(19) United States
(12) Patent Application Publication
(10) Pub. No.: US 2014/0164101 A1
(43) Pub. Date: Jun. 12, 2014

(54) SYSTEMS AND METHODS FOR PERSONALIZED OFFLINE MOBILE ADVERTISING

(71) Applicant: YAHOO! INC., Sunnyvale, CA (US)

(72) Inventor: Nagalinga Raju S, Bangalore (IN)

(73) Assignee: YAHOO! INC., Sunnyvale, CA (US)

(21) Appl. No.: 13/709,616

(22) Filed: Dec. 10, 2012

(51) Int. Cl. G06Q 30/02

(52) U.S. Cl. CPC G06Q 30/0267
USPC 705/14.45; 705/14.64

(57) ABSTRACT

Systems and methods for serving offline ads in a mobile device are provided. The mobile device includes a processor configured to determine whether the mobile device is online or offline. The mobile device includes a screen configured to display an offline ad in an active mobile application when the mobile device is offline. The mobile device includes an impression database configured to store impression information with the displayed offline ad and a communication unit configured to synchronize information between the mobile device and an online ads server when the mobile device is online. The synchronized information includes at least one of the following: offline ads impression counts, offline personalization information, and ads related to the offline personalization information.

### FIELD

This application relates generally to serving advertisements or ads. More particularly, it relates to systems and methods configured to show personalized offline ads on a mobile device.

### BACKGROUND

Online advertising is a form of promotion that uses the Internet and World Wide Web to deliver marketing messages to attract potential customers. Examples of online advertising include contextual ads on search engine results pages, banner ads, blogs, rich media Ads, social network advertising, interstitial ads, online classified advertising, advertising networks and e-mail marketing. Many of these types of online ads are served by an ad server.

Most of the online ads are displayed on a screen in a mobile device or computer. Usually, online ads are served when the mobile device or computer is connected to the Internet. However, as more and more mobile devices are available and the mobile devices are not necessarily connected to the Internet all the time, there is a need to serve ads to these offline mobile devices to increase ads revenue.

### SUMMARY

A first embodiment discloses a method for serving ads in a mobile device having a processor. The processor determines whether the mobile device is online or offline. When the mobile device is offline, the mobile device displays an offline ad in an active mobile application. The processor is configured to store impression information with the displayed offline ad in an impression database in the mobile device and synchronize information between the mobile device and an online ads server when the mobile device returns online. The synchronized information may include at least one of the following: offline ads impression counts, offline personalization information, and ads related to the offline personalization information.

A second embodiment discloses a non-transitory computer-readable storage medium storing a set of instructions for serving ads in a mobile device having a processor. The set of instructions direct the processor to determine whether the mobile device is online or offline. The set of instructions direct the processor to display, in the mobile device, an offline ad in an active mobile application when the mobile device is offline. The set of instructions direct the processor to store impression information with the displayed offline ad in an impression database in the mobile device and synchronize information between the mobile device and an online ads server when the mobile device returns online. The synchronized information may include at least one of the following: offline ads impression counts, offline personalization information, and ads related to the offline personalization information.

Another embodiment discloses a mobile device for serving offline ads. The mobile device includes a processor configured to determine whether the mobile device is online or offline. The mobile device includes a screen configured to display an offline ad in an active mobile application when the mobile device is offline. The mobile device includes an impression database configured to store impression information with the displayed offline ad and a communication unit configured to synchronize information between the mobile device and an online ads server when the mobile device returns online. The synchronized information may include at least one of the following: offline ads impression counts, offline personalization information, and ads related to the offline personalization information.

### BRIEF DESCRIPTION OF THE DRAWINGS

FIG. 1 illustrates a block diagram of one embodiment of an environment in which a system for serving offline ads may operate;

FIG. 2 illustrates a block diagram of an embodiment of a method for serving offline ads in a mobile device;

FIG. 3 illustrates an embodiment of a mobile device; and

FIG. 4 illustrates an illustrative example of a pop-window when a displayed offline ad is clicked.

### DETAILED DESCRIPTION OF THE DRAWINGS

Many mobile ad networks serve ads only to online users. However, as data rates get more expensive and mobile service providers abandon unlimited data plans, more and more Smartphone users and users of other mobile devices connect to the internet only when necessary. Further, batteries in Smartphones drain very fast with heavy data usage. Thus, many users do not turn on data service all the time and many Smartphones or other mobile devices are not online all the time. Advertisers, on the other hand, would like to serve ads on Smartphones whenever possible, even when Smartphones and other mobile devices are offline, i.e., not actively connected to a data connection with Internet access. Thus, there is a need for serving targeted offline ads on the offline mobile devices for mobile users.

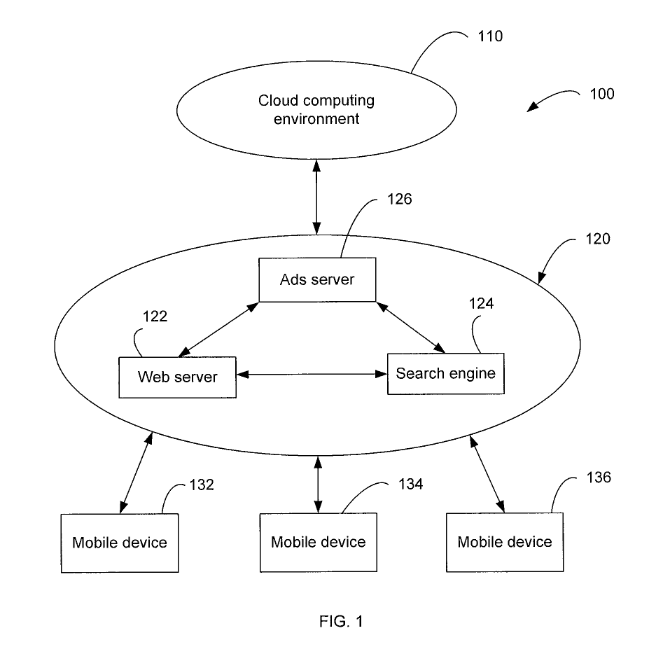

FIG. 1 illustrates a block diagram of one embodiment of an environment 100 in which a system for serving offline ads may operate. However, it should be appreciated that the systems and methods described below are not limited to the specific illustrative embodiment.

The environment 100 may include a cloud computing environment 110 and a connected server system 120 including a web server 122, a search engine 124, and an ads server 126. The web server 122 may be a computer, a server, or any other computing device known in the art, or the web server 122 may be a computer program, instructions, and/or software code stored on a computer-readable storage medium that runs on a processor of a single server, a plurality of servers, or any other type of computing device known in the art. The web server 122 delivers content, such as a web page, using the Hypertext Transfer Protocol and/or other protocols. The web server 122 may also be a virtual machine running a program that delivers content. The search engine 124 may be a computer system, one or more servers, or any other computing device known in the art, or the search engine 124 may be a computer program, instructions, and/or software code stored on a computer-readable storage medium that runs on a processor of a single server, a plurality of servers, or any other type of computing device known in the art. The search engine 124 is designed to help users find information located on the Internet or an intranet.

The ads server 126 may be a computer system, one or more servers, or any other computing device known in the art, or the ads server 126 may be a computer program, instructions and/or software code stored on a computer-readable storage medium that runs on a processor of a single server, a plurality of servers, or any other type of computing device known in the art. The ads server 126 is configured to provide digital ads to a web user based on display conditions requested by the advertiser. Additionally or alternatively, the ads server 126 may be configured to provide an offline ads database to the mobile devices when they are online and the user installs an application offering offline ads or supported by offline ads.

The environment 100 may further include a plurality of mobile devices 132, 134, and 136. The mobile devices may be a Smartphone, a personal digital aid, a digital reader, a Global Positioning System (GPS) receiver, or any other mobile device that may be used to access the Internet.

Generally, an advertiser or any other user can use a mobile device to access information on the server system 120. For example, the advertiser may purchase digital ads based on an auction model of buying ad space or a guaranteed delivery model by which an advertiser pays a minimum cost per thousand impressions (CPM) to display the digital ad. An impression is a single display of the ad to a mobile device such as the mobile devices 132, 134, 136 or another device accessible over the internet. Following an impression, a user of the device may select the ad by clicking on it and having a web browser of the device redirected to another location on the network. Also, the user may perform some subsequent action, such as making a purchase. Typically, advertisers would pay more for higher click probability. Click probability is a measure of the likelihood that a user of a mobile device will click on or select an ad viewed on the mobile device or other device. Offline ads provide personalized ads when the mobile device is offline and thus increase the number of impressions and the click probability.

For example, a user may utilize one of the mobile devices 132, 134, 136 to play an offline game without connecting to the data service. The mobile device may be disconnected from the data service when the user turns off the radio in the mobile devices so no data may be communicated, or when the mobile device enters so-called airplane mode, or when the mobile device leaves a geographic area where the data service is available from a server over a radio link. The mobile device is configured to show offline ads in the game to the user and record impression information with the offline ads in a local database. In addition or alternatively, when the user later connects to the data service, the mobile device can submit the recorded data in the local database to the online ads server 126. The disclosed method may also apply to serving ads in other offline applications, or in any other situations or platforms with the need to serve offline ads to potential customers.

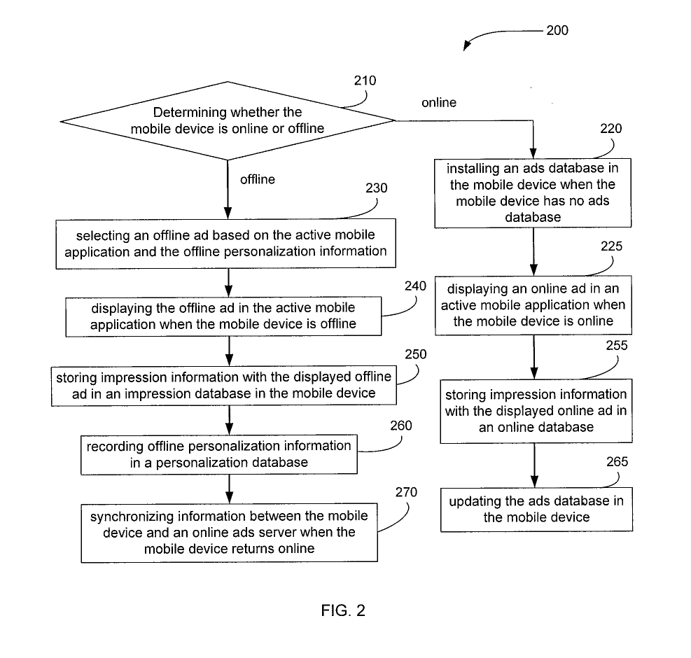

FIG. 2 illustrates a flow diagram 200 of an embodiment of a method for serving offline ads in a mobile device. The mobile device includes at least a hardware processor and computer readable media such as hard disk, computer memory, or other data storage hardware. An embodiment of the method may include the following steps. Other steps may be added or substituted.

In step 210, the mobile device determines, in the processor, whether the mobile device is online or offline. For example, the processor may determine whether the mobile device is online or offline by checking whether there is an active data connection between the mobile device and an online server. The processor may also check whether the user has turned off the data connection by disabling the radio antenna or entering a flight mode. The mobile device may be offline because the data network is not available or the user has reached its data service limit. Alternatively or additionally, the processor may be configured to set a variable to indicate whether the data connection is turned on or turned off.

In step 220, if the mobile device is online, the mobile device installs an ads database in the mobile device when the mobile device has no ads database. The ads database may be provided from the ads server 126 or other servers in FIG. 1. The ads database is configured to store offline ads candidates locally in the mobile device. This step may only need to be run once when a sponsored mobile application is installed. The user may have the choice to choose whether the ads database should be installed and how much local storage the database can use.

In step 225, the mobile device displays an online ad in an active mobile application when the mobile device is online. The online ad may be provided from the ads server 126 directly or may be provided from the ads database in the mobile device. A user may interact with the online ad in this case. For example, the user may click on the online ad and see more information about the online ad in a new webpage or make an online reservation.

In step 255, if the mobile device is online, the mobile device may transfer the impression information with the displayed online ad to an online server so that the online server can store the impression information in an online impression database. Alternatively, the mobile device may store the impression information locally in the mobile device and transfers such impression information later.

In step 265, an online server may update the ads data base in he mobile device. For example, the online server may send update to the mobile device based on client request or impression information. An ad may be removed from the ads database if the impression information indicates that it has been shown a certain times. A new ad may be added to the ads database if a client requests to show the new add in related applications which the mobile user has installed.

In step 230, if the mobile device is offline, the mobile device selects an offline ad based on the active mobile application and the offline personalization information when the mobile device is offline. The offline ads may be selected randomly from available ads candidates in the absence of relevant information about the mobile user. If the relevant information about the mobile user is available, the offline ads may be selected according to the available relevant information such as the content of the active mobile application, the category of the active mobile application, or the service provided by the active mobile application. For example, if the active mobile application is a game application, the mobile device may select an offline ads related to a similar game in the same category or a game from the same developer. The offline personalization information may include previous click history and input history. The mobile device may select the offline ad based on the personalization information such as application download history, chatting history, the age of the user, the gender of the user, the education background of the user, the location of the user, and so on. Alternatively or additionally, the offline ads displayed may be based on the target segment (e.g. Male with age 15-39 living in Arizona) chosen by an advertiser. The Advertisement provider may use this input along with any personalization information he has collected over time to provide more relevant Ads.

In step 240, the mobile device displays the offline ad in an active mobile application when the mobile device is offline. The mobile device may display the same ad or a different ad when the mobile device is online. The mobile device may update or refresh the offline ads from time to time even when the mobile device is still in offline status. For example, the mobile device may first select a plurality of offline ad candidates and then serve the offline ads one by one every five or ten minutes. Alternatively, the mobile device may be configured to show a different offline ad when a different application is active. For example, the mobile device may display an offline ad when an application starts or ends. The mobile device may show an offline ad when the user receives a notification or types on the screen. The displayed ad may be shown on the top or bottom of the screen or in the center region. Display of the offline ad may be considered an impression of the offline ad.

In step 250, the mobile device stores impression information with the displayed offline ad in an impression database in the mobile device. The impression information may include click history, display duration, calls made, addition to wish list, store visit, store search, store locating, or other reasonable user interaction with the displayed offline ad. For example, the mobile device may record, in the impression database, impression data when the offline ad is displayed or viewed by the user of the mobile device, clicked by the user of the mobile device or otherwise interacted with by the user of the mobile device. The mobile device may respond different according to the different user interactions.

In step 260, the mobile device records offline personalization information in a personalization database. The offline personalization information may include click history, input history, time spent on active applications, time spent on listening to music, media viewing or listening history, geography information, or any non-private personalization information the user agrees to share with application developers.

In step 270, the mobile device synchronizes information between the mobile device and an online ads server when the mobile device is online. For example, the mobile device may transmit the offline ad impression counts and the offline personalization information to the online ads server 126 in FIG. 1. Additionally or alternatively, the online ads server 126 may transmit ads related to the offline personalization information from its online ads database to the mobile device.

The disclosed method may be stored as computer-readable instructions and data in a computer-readable storage medium in the mobile device. The computer-readable storage medium is accessible to at least one hardware processor. The processor is configured to implement the stored instructions to serve offline ads accordingly.

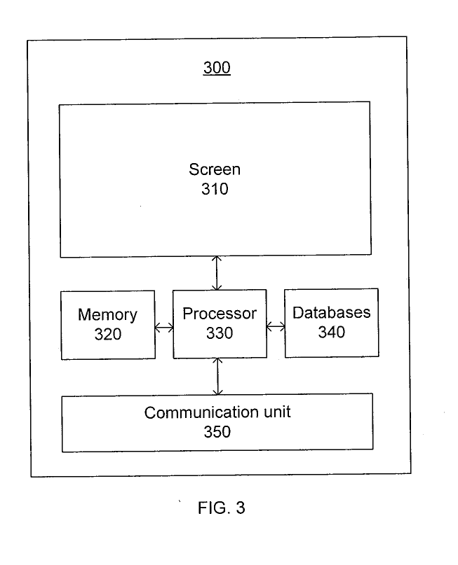

FIG. 3 illustrates an embodiment of a mobile device 300. The mobile device 300 includes a processor 330 that controls a screen 310. Under control of the processor 330, text and images may be displayed on the screen 310. The processor 330 can also access local storage including memory 320 and databases 340 in a non-transitory storage medium. The processor 330 further communicates with a communication unit 350. The communication unit 350 may include encoder, decoder, and antennas configured to transmit data wirelessly. The processor 330 is configured to select offline ad from databases 340 and serve offline ads on its screen 310.

The databases 340 may include an impression database configured to store impression information with the displayed offline ad. The databases 340 may further include an ads database configured to store offline ads. The databases 340 may further include a personalization database configured to store offline personalization information. These databases may be combined to one database if necessary.

Once the mobile device 300 returns online, the processor 330 may instruct the communication unit 350 to update the databases 340 and synchronize information between the mobile device 300 and an online ads server 126 in FIG. 1.

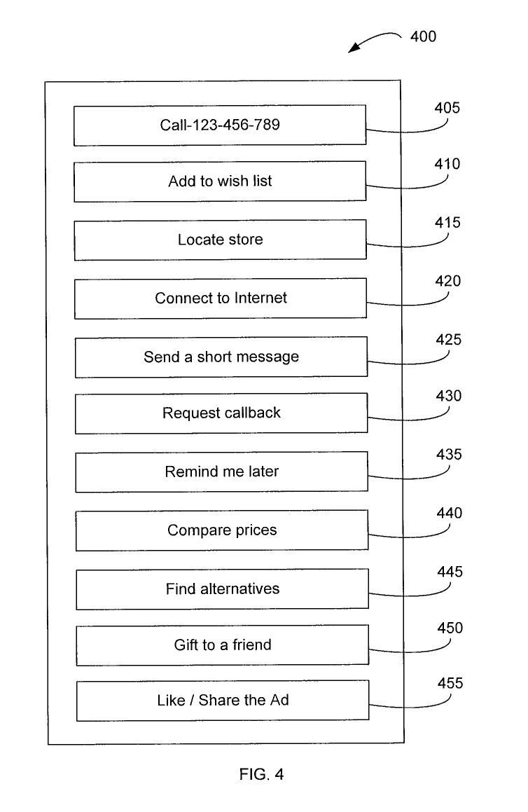

FIG. 4 illustrates an illustrative example of a pop-window 400 when a displayed offline ad is clicked. The pop-window 400 may include one or more of the options based on the context of the offline ad. For example, the pop-window 400 may includes a menu 405 showing “Call-123-456-789”, which is the contact phone number of the clicked offline ads. If the user clicks on this menu 405, the mobile device will dial the corresponding contact number.

The menu 410 shows “Add to Wish List.” If the second menu 410 is clicked by the user, the mobile device may activate an application to add the clicked offline ads to a wish list maintained for the user. For example, an item in the wish list may be a future event scheduled using the calendar application with the corresponding keywords in the offline ad. For example, when the mobile user viewed an offline ad about a wireless mouse and adds it to a wish list. The user may be notified of the availability of the mouse when he drives by any store that has the mouse in stock. The user may also be notified of any offers or deals available for any items in the wish list.

The menu 415 shows “Locate Store.” If the third menu 415 is clicked by the user, the mobile device may activate a navigation or map application to show the corresponding store address in the navigation or map application.

The menu 420 shows “Connect to Internet.” If the menu 420 is clicked by the user, the mobile device may activate data service to connect the mobile device to the Internet. This may need further confirmation from the user which data service the user would like to turn on if there are multiple connections available such as Wi-Fi, 3G, or 4G connections. Once the mobile device is online, the mobile device may synchronize information between the mobile device and an online ads server.

The menu 425 shows “Send a short message.” If the menu 425 is clicked by the user, the mobile device may activate a short message application including a link to the displayed ad or other descriptions about the service or product on the ad.

The menu 430 shows “Request callback.” If the menu 430 is clicked by the user, the mobile device may send an email or short message to the advertiser so that the advertiser can contact the user later.

The menu 435 shows “Remind me later.” If the menu 435 is clicked by the user, the mobile device may open an application so that the user can add a reminder to his calendar. The reminder may include the necessary contact information and product information about the displayed ad.

The menu 440 shows “Compare prices.” If the menu 440 is clicked by the user, the mobile device may activate the data service and compare the prices of the displayed product or service online. The mobile device may also open an application that has the capability of comparing prices in a specific location according to the position information from a Global Positioning System (GPS) sensor.

The menu 445 shows “Find alternatives.” If the menu 445 is clicked by the user, the mobile device may activate the data service and connect to the Internet to find alternative product or service similar to the one shown in the offline ad.

The menu 450 shows “Gift to a friend.” If the menu 450 is clicked by the user, the mobile device may activate the data service and add the displayed product or service in to a shopping cart with the gift option checked. The user may then input contact information of the friend to continue checking out.

The menu 455 shows “Like/Share the ad.” If the menu 455 is clicked by the user, the mobile device may open a social network application so that the user may like and/or share information about the ad with his friends in the social network.

From the foregoing, it can be seen that the present embodiments provide a solution to serve offline ads to increase ads revenue. The disclosed embodiments install a local offline ads database to a mobile device and update both the offline ads database and an online impression databases when the mobile device is online. Although the examples are about serving offline ads in a mobile device, the disclosed methods and systems may be used to serve offline ads in other mobile terminals.

It is therefore intended that the foregoing detailed description be regarded as illustrative rather than limiting, and that it be understood that it is the following claims, including all equivalents, that are intended to define the spirit and scope of this invention.

1. A method for serving ads in a mobile device having a processor, the method comprising:
determining, in the processor, whether the mobile device is online or offline;
displaying, in the mobile device, an offline ad in an active mobile application when the mobile device is offline;
storing impression information with the displayed offline ad in an impression database in the mobile device; and
synchronizing information between the mobile device and an online ads server when the mobile device returns online,
wherein the synchronized information comprises at least one of the following: offline ads impression counts, offline personalization information, and ads related to the offline personalization information.

2. The method of claim 1, further comprising: installing an ads database and a mobile application in the mobile device.

3. The method of claim 2, further comprising: selecting, from the ads database, the offline ad based on the active mobile application and the offline personalization information.

4. The method of claim 1, further comprising: recording, in the impression database, impression data when the offline ad is displayed or clicked.

5. The method of claim 1, further comprising: recording offline personalization information in a personalization database.

6. The method of claim 2, wherein synchronizing ads information between the mobile device and the online ads server comprises:
transmitting the offline ad impression counts and the offline personalization information to the online ads server.

7. The method of claim 2, wherein synchronizing ads information between the mobile device and the online ads server comprises:
transmitting ads related to the offline personalization information from the online ads server to the mobile device.

8. A non-transitory computer-readable storage medium storing a set of instructions for serving ads in a mobile device having a processor, the set of instructions to direct the processor to perform acts of:
determining whether the mobile device is online or offline;
displaying, in the mobile device, an offline ad in an active mobile application when the mobile device is offline;
storing impression information with the displayed offline ad in an impression database in the mobile device; and
synchronizing information between the mobile device and an online ads server when the mobile device returns online,
wherein the synchronized information comprises at least one of the following: offline ads impression counts, offline personalization information, and ads related to the offline personalization information.

9. The non-transitory computer-readable storage medium of claim 8, wherein the set of instructions direct the processor to install an ads database and a mobile application in the mobile device.

10. The non-transitory computer-readable storage medium of claim 9, wherein the set of instructions direct the processor to select, from the ads database, the offline ad based on the active mobile application and the offline personalization information.

11. The non-transitory computer-readable storage medium of claim 8, wherein the set of instructions direct the processor to record, in the impression database, impression data when the offline ad is displayed or clicked.

12. The non-transitory computer-readable storage medium of claim 8, wherein the set of instructions direct the processor to record offline personalization information in an offline personalization database.

13. The non-transitory computer-readable storage medium of claim 8, wherein synchronizing ads information between the mobile device and the online ads server comprises:
transmitting the offline ad impression counts and the offline personalization information to the online ads server.

14. The non-transitory computer-readable storage medium of claim 16, wherein synchronizing ads information between the mobile device and the online ads server comprises:
transmitting ads related to the offline personalization information from the online ads server to the mobile device.

15. A mobile device for serving offline ads, the mobile device comprising:
a processor configured to determine whether the mobile device is online or offline;
a screen configured to display an offline ad in an active mobile application when the mobile device is offline;
an impression database configured to store impression information with the displayed offline ad; and
a communication unit configured to synchronize information between the mobile device and an online ads server when the mobile device returns online,
wherein the synchronized information comprises at least one of the following: offline ads impression counts, offline personalization information, and ads related to the offline personalization information.

16. The mobile device of claim 15, further comprising an ads database configured to store offline ads.

17. The mobile device of claim 16, wherein the processor is further configured to select, from the ads database, the offline ad based on the active mobile application and the offline personalization information.

18. The mobile device of claim 15, wherein the processor is further configured to record, in the impression database, impression data when the offline ad is displayed or clicked.

19. The mobile device of claim 15, wherein the processor is further configured to record offline personalization information in a personalization database.

20. The mobile device of claim 15, wherein the processor is further configured to transmit the offline ad impression counts and the offline personalization information to the online ads server and transmit ads related to the offline personalization information from the online ads server to the mobile device.
